(19) United States
(12) Patent Application Publication
(10) Pub. No.: US 2026/0302213 A1
(43) Pub. Date: Oct. 1, 2026

(54) METAL COMPOSITE COMPOUND POWDER, METHOD FOR PRODUCING METAL COMPOSITE COMPOUND POWDER, AND METHOD FOR PRODUCING POSITIVE ELECTRODE ACTIVE MATERIAL FOR LITHIUM SECONDARY BATTERY

(71) Applicant: TANAKA CHEMICAL CORPORATION, Fukui-shi, Fukui (JP)

(72) Inventor: Tomoya KURODA, Fukui-shi (JP)

(21) Appl. No.: 19/480,537

(22) PCT Filed: Jul. 4, 2024
(86) PCT No.: PCT/JP2024/024259

§ 371 Date: Oct. 31, 2025

(30) Foreign Application Priority Data
Jul. 11, 2023 (JP) 2023-113634

(51) Int. Cl. H01M 4/525; C01G 53/42; C01G 53/502

(52) U.S. Cl. CPC H01M 4/525; C01G 53/42; C01G 53/502; C01P 2002/52; C01P 2004/03; C01P 2004/50; C01P 2004/61; C01P 2004/62; C01P 2004/64; C01P 2006/40

(57) ABSTRACT

The method for producing a metal composite compound powder includes a step X of heating a wet cake which contains a metal composite hydroxide containing at least Ni, and moisture while flowing the wet cake in a heating device to scrape a surface of the metal composite hydroxide contained in the wet cake, in which a proportion of the moisture contained in the wet cake immediately before the step X is 5% by mass or more and 25% by mass or less with respect to the total mass of the wet cake, and a proportion of the moisture contained in the wet cake immediately before the step X to a retention time of the wet cake in the heating device is 11% by mass/hour or less.

### TECHNICAL FIELD

The present invention relates to a metal composite compound powder, a method for producing a metal composite compound powder, and a method for producing a positive electrode active material for a lithium secondary battery.

Priority is claimed on Japanese Patent Application No. 2023-113634, filed Jul. 11, 2023, the content of which is incorporated herein by reference.

### BACKGROUND ART

In order to improve the performance of a positive electrode active material for a lithium secondary battery, attempts have been made to control a method for producing the positive electrode active material for a lithium secondary battery from various aspects.

For example, Patent Document 1 discloses a method for producing a positive electrode active material for a lithium secondary battery, the method including a step of adjusting a particle size distribution of a metal composite compound by crushing a hydroxide raw material powder corresponding to the metal composite compound.

### CITATION LIST

### Patent Document

Patent Document 1: PCT International Publication No. WO2014/061580

### SUMMARY OF INVENTION

### Technical Problem

From the viewpoint of improving an initial efficiency of the lithium secondary battery, there is room for further improvement in physical properties of the metal composite compound which is a raw material of the positive electrode active material for a lithium secondary battery.

The present invention has been made in view of the above-described circumstances, and an object of the present invention is to provide a metal composite compound powder by which a lithium secondary battery having a high initial efficiency can be obtained and a production method thereof, and a method for producing a positive electrode active material for a lithium secondary battery.

### Solution to Problem

The present invention has the following aspects.

[1]A method for producing a metal composite compound powder, the method including:
a step X of heating a wet cake which contains a metal composite hydroxide containing at least Ni, and moisture while flowing the wet cake in a heating device to scrape a surface of the metal composite hydroxide contained in the wet cake,
in which a proportion of the moisture contained in the wet cake immediately before the step X is 5% by mass or more and 25% by mass or less with respect to a total mass of the wet cake, and
a proportion of the moisture contained in the wet cake immediately before the step X to a retention time of the wet cake in the heating device is 11% by mass/hour or less.

[2] The method for producing a metal composite compound powder according to [1],
in which a maximum retention temperature in the step X is 100° C. or higher and 300° C. or lower.

[3] The method for producing a metal composite compound powder according to [1] or [2],
in which the retention time is 0.2 to 8 hours.

[4] The method for producing a metal composite compound powder according to any one of [1] to [3],
in which a proportion of moisture contained in a powder containing the metal composite hydroxide immediately after the step X is 1% by mass or less with respect to a total mass of the powder containing the metal composite hydroxide.

[5] The method for producing a metal composite compound powder according to any one of [1] to [4], further including, before the step X:
a step of neutralizing a solution containing at least a nickel salt solution under conditions of a pH of 10 or more and 13 or less and a temperature of 20° C. or higher and 80° C. or lower.

[6] The method for producing a metal composite compound powder according to any one of [1] to [5], further including, before the step X:
a step of removing moisture from the wet cake such that a proportion of the moisture contained in the wet cake is 5% by mass or more and 25% by mass or less with respect to the total mass of the wet cake.

[7] The method for producing a metal composite compound powder according to any one of [1] to [6],
in which the metal composite hydroxide further contains an element M, and the element M is one or more elements selected from the group consisting of Co, Mn, Al, Fe, Cu, Ti, Mg, W, Mo, Nb, Zn, Sn, Zr, Ga, V, B, Si, S, and P.

[8]A metal composite compound powder containing:
a secondary particle which is an aggregate of a plurality of first primary particles and a plurality of second primary particles,
in which, the metal composite compound powder contains at least Ni,
when a dimension from an outermost surface of the secondary particle to a centroid in a cross section of the secondary particle is set as 100%, outermost surface of the secondary particle,
the second primary particles are located in a region of 90% or less from the centroid, and
a ratio of an average particle diameter of the second primary particles to an average particle diameter of the first primary particles is 1.5 or more.

[9] The metal composite compound powder according to [8],
in which the average particle diameter of the first primary particles is 0.1 μm or more and 1.0 μm or less.

[10] The metal composite compound powder according to [8] or [9],
in which the average particle diameter of the secondary particles is 5 μm or more and 20 μm or less.

[11] The metal composite compound powder according to any one of [8] to [10],
in which a proportion of moisture contained in the metal composite compound powder is 1% by mass or less with respect to a total mass of the metal composite compound powder.

[12] The metal composite compound powder according to any one of [8] to [11],
in which the metal composite compound powder further contains an element M, the element M is one or more elements selected from the group consisting of Co, Mn, Al, Fe, Cu, Ti, Mg, W, Mo, Nb, Zn, Sn, Zr, Ga, V, B, Si, S, and P.

[13]A method for producing a positive electrode active material for a lithium secondary battery, the method including:
calcining a mixture of the metal composite compound powder according to any one of [8] to [12] and a lithium compound.

### Advantageous Effects of Invention

According to the present invention, it is possible to provide a metal composite compound powder by which a lithium secondary battery having a high initial efficiency can be obtained and a production method thereof, and a method for producing a positive electrode active material for a lithium secondary battery.

### BRIEF DESCRIPTION OF DRAWINGS

FIG. 1 A schematic cross-sectional view of a secondary particle of a metal composite compound powder in one aspect of the present embodiment.

FIG. 2 A scanning electron microscope image of the metal composite compound powder in one aspect of the present embodiment.

FIG. 3 A scanning electron microscope image of a metal composite compound powder in which a ratio of an average particle diameter of second primary particles to an average particle diameter of first primary particles is less than 1.5.

FIG. 4 A schematic configuration view showing an example of a lithium secondary battery.

FIG. 5 A schematic view representing an example of an all-solid-state lithium secondary battery.

### DESCRIPTION OF EMBODIMENTS

Hereinafter, the metal composite compound powder in one aspect of the present invention will be described. In a plurality of embodiments to be described below, preferred examples or conditions may be shared. In addition, in the present specification, each term is defined as follows.

In the present specification, a metal composite compound powder is hereinafter referred to as “MCC”, and a positive electrode active material for a lithium secondary battery (cathode active material for lithium secondary batteries) is hereinafter referred to as “CAM”.

“Ni” refers to a nickel atom, not a nickel metal. “Co”, “Al”, and the like also refer to a cobalt atom, an aluminum atom, and the like, respectively.

In a case where a numerical range is described as, for example, “1 to 10 μm”, the numerical range means a range from 1 μm to 10 μm, and means a numerical range including 1 μm as a lower limit value and 10 μm as an upper limit value.

“Cumulative volume particle size” is a value measured by a laser diffraction scattering method. Specifically, 0.1 g of the MCC is added to 50 ml of a 0.2% by mass sodium hexametaphosphate aqueous solution to obtain a dispersion liquid in which the MCC is dispersed. Next, a particle size distribution of the obtained dispersion liquid is measured using a laser diffraction scattering particle size distribution measuring device (for example, MASTERSIZER 2000 manufactured by Malvern Panalytical Ltd.) to obtain a volume-based cumulative particle size distribution curve. In the obtained cumulative particle size distribution curve, a value of a particle diameter at 50% cumulative from a fine particle side is a 50% cumulative volume particle size (hereinafter, may be described as D₅₀) and is an average particle diameter (μm) of the secondary particles in the present specification.

“Compositional analysis of MCC” is analyzed by the following method. For example, the MCC is dissolved in hydrochloric acid, and then measurement is performed using an ICP emission spectrometer. As the ICP emission spectrometer, for example, Optima 7300 manufactured by Perkin Elmer Inc. can be used. The composition of the metal composite hydroxide can also be measured in the same manner.

In the present specification, “method for producing positive electrode for lithium secondary battery” is as follows. The CAM, a conductive material (Acetylene Black), and a binder (PVdF) are added and kneaded with a formulation of CAM:conductive material:binder=92:5:3 (mass ratio) to prepare a paste-like positive electrode material mixture. During the preparation of the positive electrode mixture, N-methyl-2-pyrrolidone is used as an organic solvent.

The obtained positive electrode material mixture is applied onto an Al foil having a thickness of 40 μm, which is to serve as a current collector, and dried in a vacuum at 150° C. for 8 hours, thereby obtaining a positive electrode for a lithium secondary battery. The electrode area of the positive electrode for a lithium secondary battery is set to 1.65 cm².

In the present specification, “method for producing lithium secondary battery” is as follows. The following operation is carried out in a glove box under an argon atmosphere. The positive electrode for a lithium secondary battery, produced in the section of “Production of positive electrode for a lithium secondary battery”, is placed on the lower lid of a part for a coin-type battery R2032 (manufactured by Hohsen Corp.) with an aluminum foil surface facing downward, and a laminated film separator (a 16 μm-thick laminate having a heat-resistant porous layer laminated on a polyethylene porous film) is placed on the positive electrode. 300 μl of an electrolytic solution is injected therein. As the electrolyte solution, a liquid prepared by dissolving LiPF₆ in a mixed solution of ethylene carbonate, dimethyl carbonate, and ethyl methyl carbonate in a volume ratio of 30:35:35 to 1 mol/l is used.

Next, metal lithium is used as a negative electrode, and the negative electrode is placed on an upper side of the laminated film separator, covered with an upper lid through a gasket and caulked with a caulking machine, thereby producing a lithium secondary battery (coin type half cell R2032).

“Initial efficiency” means a value measured by performing charging and discharging of a lithium secondary battery under the following conditions.

### (Charging and Discharging Test)

Testing temperature: 25° C.

Charging maximum voltage: 4.3 V, charging current: 0.2 CA, constant current constant voltage charging

Discharging minimum voltage: 2.5 V, discharging current density: 0.2 CA, constant current discharging

### (Initial Efficiency)

Initial efficiency (%)=Initial discharge capacity (mAh/g)/Initial charge capacity (mAh/g)×100

### <Production of MCC>

The method for producing MCC in one aspect of the present invention includes a step of heating a wet cake which contains a metal composite hydroxide containing at least Ni, and moisture while flowing the wet cake in a heating device to scrape a surface of the metal composite hydroxide contained in the wet cake (hereinafter, may be referred to as a step X), in which a proportion of the moisture contained in the wet cake immediately before the step X is 5% to 25% by mass with respect to the total mass of the wet cake, and a proportion of the moisture contained in the wet cake immediately before the step X to a retention time of the wet cake in the heating device is 11% by mass/hour or less. The “immediately before the step X” refers to within 30 minutes before the step X is performed; and the “immediately after the step X” refers to within 30 minutes after the step X is completed. The powder containing the metal composite hydroxide immediately after the step X may be hereinafter referred to as a powder X.

The metal composite hydroxide contains at least Ni, and preferably contains Ni and an element M. The element M is one or more elements selected from the group consisting of Co, Mn, Al, Fe, Cu, Ti, Mg, W, Mo, Nb, Zn, Sn, Zr, Ga, V, B, Si, S, and P. From the viewpoint of improving the initial efficiency, the element M is preferably one or more elements selected from the group consisting of Co, Mn, Al, Ti, Mg, W, Nb, Zr, and B.

The metal composite hydroxide preferably contains Ni and the element M at a mole ratio represented by Formula (A), and it is preferably represented by Formula (A′).

$$Ni : M = ( 1 - x ) : x \qquad ( A )$$

$${Ni}_{( 1 - x )} {{M}_{x} ( OH )}_{2} \qquad ( {A}^{′} )$$

(In Formula (A) and Formula (A′), M is the above-described element M, and Formula (A) and Formula (A′) satisfy 0<x≤0.5.)

From the viewpoint of obtaining a lithium secondary battery having a large battery capacity, x in Formula (A) and Formula (A′) is preferably more than 0 and 0.50 or less, more preferably more than 0 and 0.40 or less, still more preferably more than 0 and 0.30 or less, and particularly preferably more than 0 and 0.25 or less.

The metal composite hydroxide more preferably contains Ni and an element M1 at a mole ratio represented by Formula (B), and it is more preferably represented by Formula (B′).

$$Ni : M1 : M 2 = ( 1 - y - z ) : y : z \qquad ( B )$$

$${Ni}_{( 1 - y - z )} {M 1}_{y} {{M 2}_{z} ( OH )}_{2} \qquad ( {B}^{′} )$$

(in Formula (B) and Formula (B′), M1 is one or more elements selected from the group consisting of Co, Mn, and Al, M2 is one or more elements selected from the group consisting of Fe, Cu, Ti, Mg, W, Mo, Nb, Zn, Sn, Zr, Ga, V, B, Si, S, and P, and Formula (B) and Formula (B′) satisfy 0<y≤0.5, 0≤z≤0.1, and 0<y+z≤0.5)

From the viewpoint of obtaining a lithium secondary battery having a large battery capacity, the lower limit value of y is preferably 0.01. The upper limit of y is preferably 0.30 or less, more preferably 0.20 or less, and still more preferably 0.15 or less. The upper limit value and lower limit value of y can be randomly combined together. y is preferably 0.01 to 0.30, more preferably 0.01 to 0.20, and still more preferably 0.01 to 0.15.

When the metal composite hydroxide contains the M2, from the viewpoint of obtaining a lithium secondary battery having favorable cycle characteristics, the lower limit value of z is more than 0, preferably 0.01. From the viewpoint of obtaining a lithium secondary battery having a large battery capacity, the upper limit value of z is preferably 0.10 and more preferably 0.08. The upper limit value and lower limit value of z can be randomly combined together. z is preferably 0 to 0.10, more preferably more than 0 and 0.10 or less, and still more preferably 0.01 to 0.08.

Hereinafter, a method for producing the MCC containing Ni and the element M will be described as an example. First, the powder X containing Ni and the element M is prepared. The powder X can be produced by a batch-type co-precipitation method or a continuous co-precipitation method.

Specifically, the powder containing the metal composite hydroxide represented by Formula (A′) described above is produced by reacting a nickel salt solution with a metal salt solution of the element M and a complexing agent, according to a continuous co-precipitation method described in JP-A-2002-201028. For example, a nickel salt solution, a cobalt salt solution, an aluminum salt solution, and a complexing agent are reacted with each other to produce a powder containing a metal composite hydroxide represented by Ni₍₁₋ₓ₎AlₐCo_{b}(OH)₂ (a+b=x).

A nickel salt which is a solute of the nickel salt solution is not particularly limited, and for example, at least one of nickel sulfate, nickel nitrate, nickel chloride, or nickel acetate can be used.

As an aluminum salt which is a solute of the aluminum salt solution, for example, at least one of aluminum sulfate or soda aluminate can be used.

As a cobalt salt which is a solute of the cobalt salt solution, for example, at least one of cobalt sulfate, cobalt nitrate, cobalt chloride, or cobalt acetate can be used.

The metal salt solution is used at a proportion corresponding to the compositional ratio of Formula (A) described above. That is, the amount of each metal salt solution is defined such that the mole ratio of Ni and the element M in the mixed solution containing the above-described metal salts corresponds to (1−x):x. In addition, as a solvent, water is used.

The complexing agent is capable of forming a complex with a nickel ion and an ion of the element M (for example, an aluminum ion and a cobalt ion); and examples thereof include ammonium ion donors (ammonium hydroxide, ammonium sulfate, ammonium chloride, ammonium carbonate, ammonium fluoride, and the like), hydrazine, ethylenediaminetetraacetic acid, nitrilotriacetic acid, uracildiacetic acid, and glycine.

The complexing agent may or may not be used. In a case where the complexing agent is used, a mole ratio of an amount of the complexing agent contained in a mixed solution of the nickel salt solution, the metal salt solution of the element M, and the complexing agent is more than 0 and 2.0 or less with respect to the total number of moles of the metal salt (the nickel salt and the metal salt of the element M).

In the co-precipitation method, it is preferable to neutralize a solution containing at least a nickel salt solution, in the present example, a mixed solution containing a nickel salt solution, a metal salt solution of the element M, and a complexing agent under conditions of pH of 10 to 13 and 20° C. to 80° C. Specifically, the temperature of the reaction vessel is set to 20° C. to 80° C., and an alkali metal hydroxide is added to the mixed solution so that the pH is 10 to 13. The alkali metal hydroxide is, for example, sodium hydroxide or potassium hydroxide.

The value of pH in the present specification is defined as a value measured in a case where the temperature of the mixed solution is 40° C. In a case where the temperature of the mixed solution sampled in the reaction vessel is not 40° C., the mixed solution is heated or cooled to 40° C., and then the pH is measured.

In a case where the nickel salt solution and the metal salt solution of the element M described above are continuously supplied to the reaction vessel together with the complexing agent, Ni and the element M are react with each other, and the metal composite hydroxide represented by Formula (A′) is generated.

In the reaction, the temperature of the reaction vessel is controlled preferably in a range of 30° C. to 80° C. and more preferably in a range of 50° C. to 80° C.

In addition, in the reaction, the pH value of the mixed solution in the reaction vessel is set to preferably 10 to 12, more preferably 10.5 to 12.0, and still more preferably 10.5 to 11.7, and fluctuation of the pH is controlled within ±0.2.

As the reaction vessel which is used in the continuous co-precipitation method, an overflow type reaction vessel can be used to separate the formed reaction precipitate.

In a case of producing the metal composite hydroxide by a batch co-precipitation method, examples of the reaction vessel include a reaction vessel which does not include an overflow pipe, and a device that has a mechanism for concentrating the overflowed reaction precipitate in a concentrating tank connected to the overflow pipe and circulating it back to the reaction vessel.

Various gases, for example, an inert gas such as nitrogen, argon, and carbon dioxide, an oxidizing gas such as air and oxygen, or a mixed gas thereof, may be supplied into the reaction vessel.

By appropriately controlling the concentration of the metal salt supplied to the reaction vessel, the temperature of the reaction vessel, the pH of the mixed liquid in the reaction vessel, and the like, the average particle diameters of the second primary particles and the secondary particles in the MCC can be controlled. In addition, in a case where the MCC obtained by neutralization under the above-described conditions is used, the initial efficiency of the lithium secondary battery can be improved.

After the above-described reaction, the neutralized reaction precipitate is washed. The reaction precipitate is preferably washed with water or an alkaline washing liquid. As the alkaline washing liquid, a sodium hydroxide aqueous solution is preferable. In addition, the reaction precipitate may be washed using a washing liquid containing a sulfur element. Examples of the washing liquid containing a sulfur element include a sulfate aqueous solution of potassium or sodium. In this manner, a wet cake containing the metal composite hydroxide and moisture is obtained.

It is preferable that, after the wet cake is produced and before the step X, the moisture is removed from the wet cake such that a proportion of the moisture contained in the wet cake is 5% to 25% by mass with respect to the total mass of the wet cake. Examples of the method of removing the moisture include centrifugation and suction filtration. The proportion of the moisture in the wet cake immediately before the step X is preferably 5% to 23% by mass, and more preferably 5% to 21% by mass with respect to the total mass of the wet cake. When the proportion of the moisture contained in the wet cake is 5% by mass or more with respect to the total mass of the wet cake, the wet cake is in a state of being appropriately moist in the subsequent step X, and thus the surface of the metal composite hydroxide contained in the wet cake is easily scraped off due to the fluidity of the wet cake. When the proportion of the moisture contained in the wet cake is 25% by mass or less with respect to the total mass of the wet cake, the surface of the metal composite hydroxide is easily scraped off in the subsequent step X, and the moisture can be sufficiently removed. As a result, it is possible to obtain the MCC in which the average particle diameter of the first primary particles, the average particle diameter of the second primary particles, the ratio (A/B) of the average particle diameter A of the second primary particles to the average particle diameter B of the first primary particles, and the proportion of moisture, which will be described later, are within the ranges described later. In addition, the initial efficiency of the lithium secondary battery using the obtained MCC can be improved.

In the step X, the above-described wet cake is heated while flowing, and the surface of the metal composite hydroxide is scraped. By the heating, the moisture in the wet cake is removed. The step X is performed in a heating device such as a fluidized drying device. Examples of the fluidized drying device include a rotary kiln and a paddle dryer.

Specifically, the wet cake is charged from a charge port of the heating device, and the moisture is removed while the wet cake is allowed to flow. The powder X which has passed through the heating device is discharged from a discharge port of the heating device.

The maximum retention temperature in the step X is preferably 100° C. or higher, and more preferably 120° C. or higher. The maximum retention temperature is preferably 300° C. or lower, and more preferably 250° C. or lower. The maximum retention temperature is preferably 100° C. to 300° C. and more preferably 120° C. to 250° C. When the above-described maximum retention temperature is equal to or higher than the above-described upper limit value, the moisture can be appropriately removed, and when the maximum retention temperature is equal to or lower than the above-described lower limit value, the crystal state of the metal composite hydroxide is less likely to change.

The retention time of the wet cake in the heating device in the step X is preferably 0.2 hours or longer, and more preferably 0.5 hours or longer. The above-described retention time is preferably 8 hours or shorter, and more preferably 6 hours or shorter. The above-described retention time is preferably 0.2 to 8 hours and more preferably 0.5 to 6 hours. When the retention time is within the above-described range, the surface of the metal composite hydroxide is moderately scraped.

In the step X, the proportion of the moisture contained in the wet cake immediately before the step X to the retention time of the wet cake in the heating device is preferably 10.5% by mass/hour or less and more preferably 10.0% by mass/hour or less, and preferably 0.50% by mass/hour or more and more preferably 0.80% by mass/hour or more. The proportion of the moisture contained in the wet cake immediately before the step X to the retention time of the wet cake in the heating device is preferably 0.50 to 10.5% by mass/hour and more preferably 0.80 to 10.0% by mass/hour.

A wall surface friction distance of the wet cake in the heating device is preferably 300 to 5,000 m. When the wall surface friction distance is 300 to 5,000 m, the surface of the metal composite hydroxide is moderately scraped. The wall surface friction distance is calculated by the following method.

When the wet cake is moved by moving the container itself in which the wet cake of the heating device is retained, the wall surface friction distance is calculated by Expression (1).

Wall surface friction distance (m)=Peripheral length of cross section of container in axial direction (m)×Peripheral speed of container (rpm)×Retention time (min) Expression (1)

When the above-described container of the heating device does not move and a rotating body rotates in the container to move the wet cake, the wall surface friction distance is calculated by Expression (2).

Wall surface friction distance (m)=Circumference length of orbit of rotating body (m)×Circumferential speed of rotating body (rpm)×Retention time (min) Expression (2)

In addition, as the atmosphere in the step X, it is possible to use air, oxygen, nitrogen, argon, or a mixed gas thereof, and air is preferable.

By heating the wet cake while allowing the wet cake to flow under the above-described conditions, friction occurs between the particles of the metal composite hydroxide contained in the wet cake and between the particles and a wall surface of fluidized drying device or a movable unit surface of the rotary blade. Therefore, the surface of the metal composite hydroxide is scraped, and thus the surface is smooth. As a result, it is possible to obtain the MCC in which the average particle diameter of the first primary particles, the average particle diameter of the second primary particles, the A/B, and the proportion of moisture, which will be described later, are within the ranges described later. In addition, the initial efficiency of the lithium secondary battery using the obtained MCC can be improved.

The proportion of the moisture contained in the powder X immediately after the step X is 1% by mass or less with respect to the total mass of the powder X, and is preferably 0.9% by mass or less and more preferably 0.85% by mass or less. When the proportion of the moisture in the powder X is 1% by mass or less, the initial efficiency of the lithium secondary battery obtained by using the MCC is improved. The lower limit value of the proportion of the moisture is not particularly limited, but is, for example, 0.01% by mass. The proportion of the moisture in the powder X is preferably 0.01% to 1% by mass, more preferably 0.01% to 0.9% by mass, and still more preferably 0.01% to 0.85% by mass.

By performing the step X such that the proportion of the moisture contained in the powder X immediately after the step X is within the above-described range, it is possible to obtain the MCC in which the average particle diameter of the first primary particles, the average particle diameter of the second primary particles, A/B, and the proportion of the moisture, which will be described later, are within the ranges described later.

### (Proportion of Moisture)

Here, the proportion of the moisture in the wet cake, the powder X, and the MCC described later can be obtained, for example, from a weight reduction amount of the heating drying method using an infrared moisture meter by Expression (3). The measurement sample amount in Expression (3) is the amount of the wet cake, the powder X, or the MCC.

$$Proportion of moisture ( \% by mass ) = Weight reduction amount ( g ) / Measurement sample amount ( g ) \times 100 \qquad Expression ( 3 )$$

When the MCC is the powder X, the powder X after the step X is the MCC in one aspect of the present invention. The MCC in one aspect of the present invention may be sieved after the step X.

When the MCC in one aspect of the present invention is a metal composite oxide powder, the above-described powder X is heated to produce a metal composite oxide powder. A plurality of heating steps may be carried out as necessary. The heating temperature in the present specification means a set temperature of a device. In a case of having a plurality of heating steps, the heating temperature means a temperature of a step in which the heating is performed at the highest temperature among the respective steps.

A heating temperature is preferably 400° C. to 700° C. and more preferably 450° C. to 680° C. When the heating temperature is within the above-described range, the metal composite hydroxide is sufficiently oxidized.

Examples of a time for retaining at the above-described heating temperature include 0.1 to 20 hours, and the time is preferably 0.5 to 10 hours. A temperature rising rate to the above-described heating temperature is, for example, 50 to 400° C./hour. In addition, as the heating atmosphere, it is possible to use air, oxygen, nitrogen, argon, or a mixed gas thereof.

The inside of the device may be under an appropriate oxygen-containing atmosphere. The oxygen-containing atmosphere may be a mixed gas atmosphere of an inert gas and oxygen, or may be a state in which an oxidizing agent is present in an inert gas atmosphere. In a case where the inside of the device is an appropriate oxygen-containing atmosphere, a transition metal which is contained in the metal composite hydroxide is appropriately oxidized, and it is easier to control a form of the metal composite oxide.

As oxygen or the oxidizing agent in the oxygen-containing atmosphere, a sufficient number of oxygen atoms need to be present in order to oxidize the transition metal.

In a case where the oxygen-containing atmosphere is a gas mixture atmosphere of an inert gas and oxygen, the atmosphere in the heating device can be controlled by a method such as aeration of the oxygen into the heating device or bubbling of the oxygen in the mixed solution.

As the oxidizing agent, it is possible to use a peroxide such as hydrogen peroxide, a peroxide salt such as permanganate, perchloric acid, hypochlorous acid, nitric acid, halogen, ozone, or the like.

In a case of producing the metal composite oxide powder as the MCC, the powder X is heated under the above-described conditions, whereby it is possible to obtain the MCC in which the average particle diameter of the first primary particles, the average particle diameter of the second primary particles, the A/B, and the proportion of the moisture, which will be described later, are within the ranges described later.

The CAM produced using the MCC produced by the above-described method can achieve a lithium secondary battery having a high initial efficiency.

### <Metal Composite Compound>

The MCC contains a secondary particle which is an aggregate of a plurality of first primary particles and a plurality of second primary particles, in which, the MCC contains at least Ni, and when a dimension from an outermost surface of the secondary particle to a centroid in a cross section of the secondary particle is set as 100%, the first primary particles are located in a region of less than 10% from the outermost surface of the secondary particle, the second primary particles are located in a region of 90% or less from the centroid, and a ratio of an average particle diameter of the second primary particles to an average particle diameter of the first primary particles is 1.5 or more.

The above-described MCC consists of a plurality of particles. In other words, the MCC in the present embodiment is in a form of powder. In the present embodiment, the MCC may contain only the secondary particles or may be a mixture of primary particles which do not constitute the secondary particles, and the secondary particles.

Here, the “primary particles” means particles that have no grain boundary in appearance and constitute the secondary particles. In more detail, the “primary particles” means particles in which no clear grain boundary is visible from the particle surface in the case of being observed in a visual field magnified 5,000 to 20,000 times with a scanning electron microscope or the like.

The proportion of the moisture contained in the MCC is preferably 1% by mass or less, more preferably 0.9% by mass or less, and still more preferably 0.85% by mass or less with respect to the total mass of the MCC. When the proportion of the moisture in the MCC is 1% by mass or less, the initial efficiency of the lithium secondary battery obtained by using the MCC is improved. The lower limit value of the proportion of the moisture is not particularly limited, but is, for example, 0.01% by mass. The proportion of the moisture in the MCC is preferably 0.01% to 1% by mass, more preferably 0.01% to 0.9% by mass, and still more preferably 0.01% to 0.85% by mass.

The proportion of the moisture contained in the MCC is a value measured within 30 minutes after the MCC is exposed to the air. For example, the measurement is performed within 30 minutes after the production of the MCC; or after the produced MCC is stored in a container or the like without being exposed to the air, the MCC is taken out from the container and exposed to the air, and then the measurement is performed within 30 minutes.

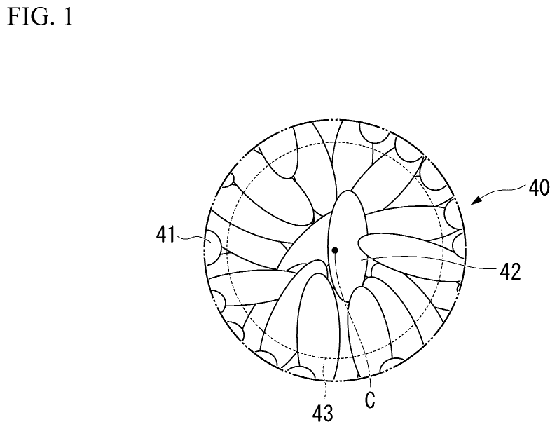

FIG. 1 is a schematic cross-sectional view of the secondary particle of the MCC in one aspect of the present embodiment. A secondary particle 40 includes first primary particles 41 and second primary particles 42. When a dimension from an outermost surface of the secondary particle 40 to a centroid C in a cross section of the secondary particles 40 is set as 100%, the first primary particles 41 refers to primary particles located in a region of less than 10% from the outermost surface of the secondary particle 40, that is, a region from the outermost surface of the secondary particle 40 to a dashed line 43 in FIG. 1. The second primary particles 42 refers to primary particles located in a region of 90% or less from the centroid C, that is, a region surrounded by the dashed line 43 in FIG. 1.

In the MCC, the first primary particles 41 present on the surface of the secondary particles are scraped. Therefore, the average particle diameter of the first primary particles 41 is smaller than the average particle diameter of the second primary particles 42 present inside the secondary particle 40. Specifically, the ratio (A/B) of the average particle diameter A of the second primary particles 42 to the average particle diameter B of the first primary particles 41 is 1.5 or more, preferably 1.55 or more, and more preferably 1.6 or more. When the A/B is equal to or more than the above-described lower value, the surface of the secondary particle 40 is in a state of being moderately scraped, and the surface is smooth. The initial efficiency of the lithium secondary battery obtained by using the MCC is improved. The upper limit value of A/B may be 2.5. The A/B is preferably 1.5 to 2.5, more preferably 1.55 to 2.5, and still more preferably 1.6 to 2.5.

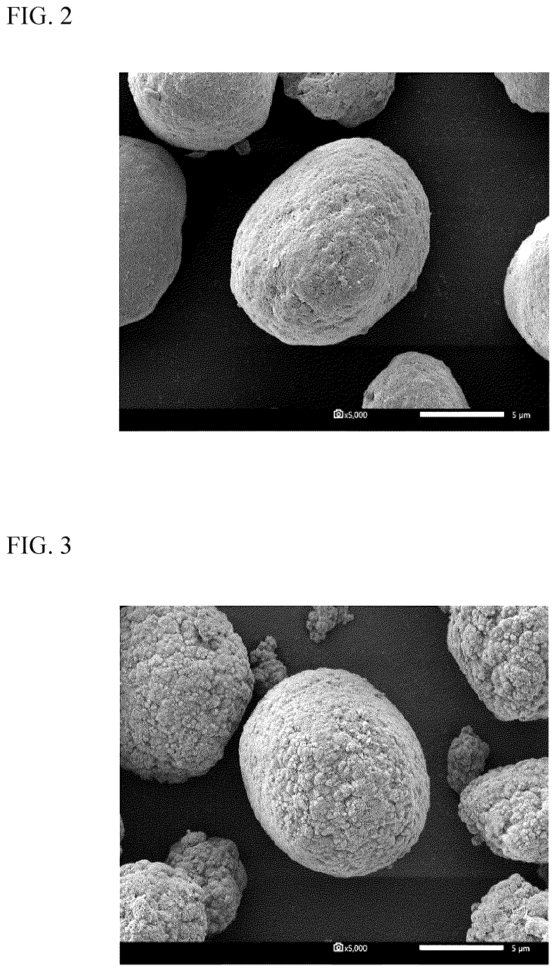

FIG. 2 is a scanning electron microscope (SEM) image of the secondary particles of the MCC in one aspect of the present embodiment. FIG. 3 is an SEM image of the MCC in which the A/B is less than 1.5. The surface of the secondary particles of the MCC in FIG. 2 is smoother than the surface of the secondary particles of the MCC in FIG. 3.

### (Average Particle Diameters of First Primary Particles and Second Primary Particles)

The average particle diameters of the first primary particles and the second primary particles are measured by the following method. First, the secondary particles of the MCC are dispersed in a resin for fixing particles. Thereafter, the mixture is subjected to vacuum degassing, and the obtained product is sandwiched between aluminum plates and then cured. In this manner, a cured product of the resin containing the secondary particles is obtained. The cured product is fixed to a sample table, and set in a cross-sectional sample production device (also referred to as a cross-sectional polisher; for example, IB-19520CCP manufactured by JEOL Ltd.). Argon ion beam processing is performed at an ion acceleration voltage of 6.0 kV to produce a cross section of the secondary particles. The obtained cross section of the secondary particles is observed with a scanning electron microscope image (hereinafter, SEM; for example, product number: JSM-IT500HR, manufactured by JEOL Ltd.) to acquire a cross-sectional image. From the cross-sectional image, 10 secondary particles having the longest dimension of the average particle diameter ±2 μm of the secondary particles, which will be described later, are selected.

A centroid of the cross-sectional image is automatically determined using, for example, Centroid function of image analysis software Image J. The dimension from the outermost surface of the secondary particle to the centroid in the cross-sectional image of the secondary particles is set as 100%, and 10 primary particles located in a region of less than 10% from the outermost surface of the secondary particle are selected. The longest diameter of each primary particle is measured, and an arithmetic mean value of the 10 primary particles is obtained. This operation is similarly performed on the 10 secondary particles selected in the above-described acquiring of the cross-sectional image, and an arithmetic mean value thereof is defined as the average particle diameter B of the first primary particles.

As described above, the centroid of the cross-sectional image is determined, and the dimension from the outermost surface of the secondary particle to the centroid in the cross-sectional image of the secondary particles is set as 100%, 10 primary particles included in a region of 90% or less from the centroid are selected. The longest diameter of each primary particle is measured, and an arithmetic mean value of the 10 primary particles is obtained. This operation is performed on the 10 secondary particles selected in the above-described acquiring of the cross-sectional image, and an arithmetic mean value thereof is defined as the average particle diameter A of the second primary particles.

The B is preferably 0.1 μm or more, more preferably 0.2 μm or more, and still more preferably 0.3 μm or more. In addition, the B is preferably 1.0 μm or less, more preferably 0.9 μm or less, and still more preferably 0.8 μm or less. The B is preferably 0.1 to 1.0 μm, more preferably 0.2 to 0.9 μm, and still more preferably 0.3 to 0.8 μm. When the B is within the above-described range, it can be said that the surface of the secondary particles is scraped and the surface is smooth. In addition, when the MCC in which the B is within the above-described range is used, the initial efficiency of the lithium secondary battery can be further improved.

The A is preferably 0.2 μm or more, more preferably 0.3 μm or more, and still more preferably 0.4 μm or more. In addition, the A is preferably 1.5 μm or less, more preferably 1.3 μm or less, and still more preferably 1.2 μm or less. The A is preferably 0.2 to 1.5 μm, more preferably 0.3 to 1.3 μm, and still more preferably 0.4 to 1.2 μm. When A is within the above-described range, it can be said that the MCC has high crystallinity. In addition, when the MCC in which the A is within the above-described range is used, the initial efficiency of the lithium secondary battery can be further improved.

D₅₀ which is an average particle diameter of the secondary particles is preferably 5 μm or more, and more preferably 7 μm or more. In addition, the D₅₀ is preferably 20 μm or less, and more preferably 18 μm or less. The D₅₀ is preferably 5 to 20 μm, and more preferably 7 to 18 μm. When the MCC in which the D₅₀ is within the above-described range is used, the initial efficiency of the lithium secondary battery can be further improved.

The MCC contains at least Ni, and preferably contains Ni and the above-described element M. The MCC may be any of the above-described powder X containing at least Ni, the metal composite oxide powder, or a mixture thereof, and is preferably the powder X containing at least Ni.

The MCC does not substantially contain Li.

It is preferable that the secondary particles contained in the MCC contain Ni and the element M at a mole ratio represented by Formula (A), and it is preferably represented by Formula (A″). A preferred range of x in Formula (A″) is the same as the preferred range of x in Formula (A) described above.

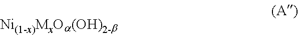

(In Formula (A″), M is the above-described element M, and Formula (A″) satisfies 0<x≤0.5, 0≤α≤3, −0.5≤β≤52, and β−α<2.)

It is more preferable that the secondary particles contained in the MCC contains Ni, an element M1, and an element M2 at a mole ratio represented by Formula (B), and it is more preferably represented by Formula (B″). Preferred ranges of y and z in Formula (B″) are the same as the preferred ranges of y and z in Formula (B) described above.

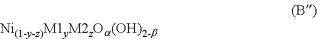

(In Formula (B″), M1 is one or more elements selected from the group consisting of Co, Mn, and Al, M2 is one or more elements selected from the group consisting of Fe, Cu, Ti, Mg, W, Mo, Nb, Zn, Sn, Zr, Ga, V, B, Si, S, and P, and Formula (B″) satisfies 0<y≤0.5, 0≤z≤0.1, 0<y+z≤0.5, 0≤α≤3, −0.5≤β≤2, and β−α<2.)

From the viewpoint of obtaining a lithium secondary battery having a high cycle retention rate, the element M is preferably one or more elements selected from the group consisting of Mn, Co, Al, Ti, Mg, W, B, Nb, and Zr.

### <Method for Producing CAM>

A method for producing CAM will be described. The method for producing the CAM includes at least calcining a mixture of the MCC obtained in <Production of MCC> described above and a lithium compound.

(1) Mixing of MCC with Lithium Compound

The present step is a step of mixing the lithium compound and the MCC to obtain a mixture.

As the above-described lithium compound, at least any one of lithium carbonate, lithium nitrate, lithium acetate, lithium hydroxide, lithium oxide, lithium chloride, or lithium fluoride can be used. Among the above, either of lithium hydroxide and lithium carbonate or a mixture thereof is preferable.

The lithium compound and the MCC are mixed in consideration of the compositional ratio of a final target product to obtain the mixture. An amount (mole ratio) of Li with respect to the total amount 1 of the metal atoms contained in the MCC is preferably 1.00 or more, and more preferably 1.02 or more. A calcined product is obtained by calcining the mixture of the lithium compound and the MCC as described below.

### (2) Calcining of Mixture

The CAM is obtained by calcining the mixture of the MCC and the lithium compound. The calcining may have a plurality of calcining stages having different calcining temperatures. For example, a first calcining stage, and a second calcining stage in which the calcining is performed at a higher temperature than the first calcining stage may be performed independently. Furthermore, the calcining may have a calcining stage that is performed at a different calcining temperature for a different calcining time. Before the main calcining, a preliminary calcining in which the mixture is calcined at a lower temperature than in the main calcining may be performed. In addition, after the main calcining, a post calcining in which the mixture is calcined at a lower temperature than in the main calcining may be performed.

The calcining temperature in the present specification means the temperature of the atmosphere in the calcining furnace, and is the highest temperature of temperatures retained in the calcining step (hereinafter, referred to as the maximum retention temperature). In a case where the calcining step includes a plurality of calcining stages, the calcining temperature means the temperature of a stage in which the calcining is performed at the highest temperature among the stages. The upper limit value and lower limit value of the calcining temperature can be randomly combined together.

The calcining temperature is 500° C. or higher, and is preferably 500° C. to 1,100° C. In a case where the calcining temperature is 500° C. or higher, CAM having a firm crystal structure can be obtained. In addition, in a case where the calcining temperature is 1,100° C. or lower, volatilization of lithium ions on the particle surface can be reduced.

The retention time in the calcining is preferably 1 to 50 hours. When the retention time in the calcining is 1 hour or longer, the reaction between the MCC and the lithium compound is sufficiently enhanced. When the retention time in the calcining is 50 hours or shorter, the volatilization of lithium ions is less likely to occur, and the battery performance is likely to be improved.

In the calcining, a dry air, an oxygen atmosphere, an inert atmosphere, or the like is used depending on a desired formulation. In the present embodiment, it is preferable to carry out the calcining in an oxygen atmosphere.

The mixture of the MCC and the lithium compound may be calcined in the presence of an inert melting agent. The inert melting agent may remain in the calcined product, or may be removed by washing the mixture after the calcination with a washing liquid or the like, which will be described later. As the inert melting agent, for example, those described in WO2019/177032A1 can be used.

Examples of the calcining furnace include a tunnel furnace, a roller hearth kiln, and a rotary kiln.

In this manner, the CAM is obtained by calcining the mixture of the MCC and the lithium compound.

### <CAM>

The CAM according to the present embodiment is obtained by <Method for producing CAM> described above using the above-described MCC as a raw material. In a case where the CAM is used, a lithium secondary battery in which the initial efficiency is improved is easily obtained.

### <Lithium Secondary Battery>

A suitable configuration of a lithium secondary battery in a case where the CAM is used will be described. In addition, a positive electrode for a lithium secondary battery (hereinafter, may be referred to as a positive electrode) in a case of using the CAM will be described.

An example of the lithium secondary battery suitable for a case in which the CAM is used has a positive electrode, a negative electrode, a separator interposed between the positive electrode and the negative electrode, and an electrolytic solution disposed between the positive electrode and the negative electrode.

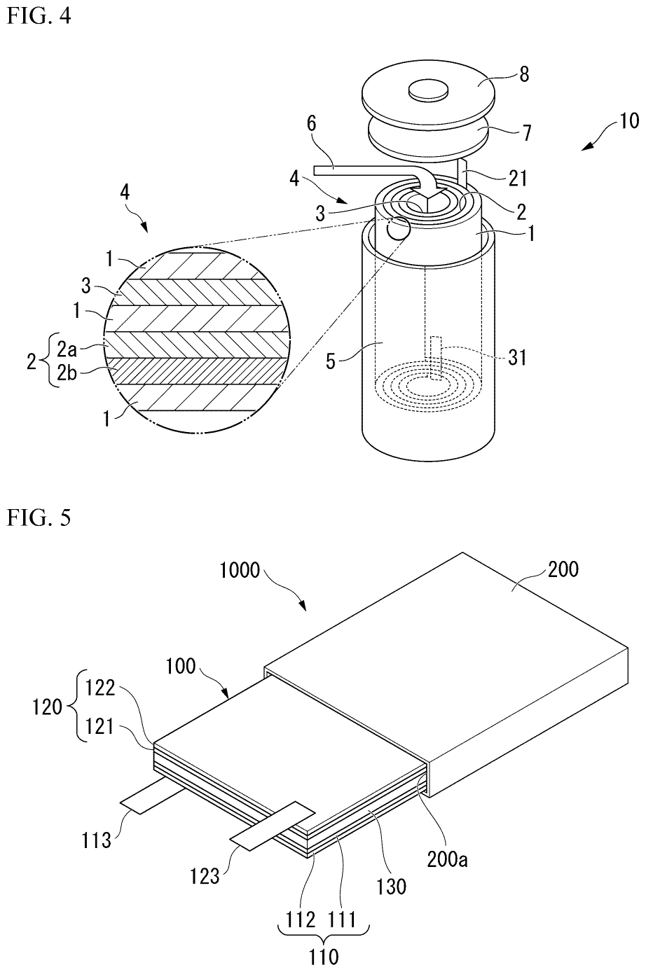

FIG. 4 is a schematic view showing an example of the lithium secondary battery. For example, a cylindrical lithium secondary battery 10 is manufactured as described below.

First, as shown in the partially enlarged view of FIG. 4, a pair of separators 1 having a strip shape, a strip-shaped positive electrode 2 having a positive electrode lead 21 at one end, and a strip-shaped negative electrode 3 having a negative electrode lead 31 at one end are laminated in order of the separator 1, the positive electrode 2, the separator 1, and the negative electrode 3 are wound to form an electrode group 4.

The positive electrode 2 includes, for example, a positive electrode active material layer 2a containing the CAM and a positive electrode current collector 2b having the positive electrode active material layer 2a formed on one surface thereof. The positive electrode 2 can be produced by first preparing a positive electrode mixture containing the CAM, a conductive material, and a binder, and supporting the positive electrode mixture on one surface of the positive electrode current collector 2b to form a positive electrode active material layer 2a.

As an example of the negative electrode 3, an electrode in which a negative electrode material mixture containing a negative electrode active material (not shown) is supported on a negative electrode current collector, and an electrode consisting of a negative electrode active material alone are exemplary examples, and the negative electrode 3 can be produced in a manner similar to that for the positive electrode 2.

Next, the electrode group 4 and an insulator (not shown) are accommodated in a battery can 5, and a can bottom is sealed. The electrode group 4 is impregnated with an electrolytic solution 6, and an electrolyte is disposed between the positive electrode 2 and the negative electrode 3. Furthermore, the upper portion of the battery can 5 is sealed with a top insulator 7 and a sealing body 8, whereby the lithium secondary battery 10 can be produced.

Examples of a shape of the electrode group 4 include a columnar shape in which the cross-sectional shape is a circle, an ellipse, a rectangle, or a rectangle with rounded corners, in a case where the electrode group 4 is cut in a direction perpendicular to a winding axis.

In addition, as the shape of the lithium secondary battery having such an electrode group 4, a shape that is specified by IEC60086, which is a standard for batteries specified by the International Electrotechnical Commission (IEC) or by JIS C 8500, can be adopted. For example, shapes such as a cylindrical shape and a square shape can be exemplary examples.

Furthermore, the lithium secondary battery is not limited to the above-described winding-type configuration, and may have a lamination-type configuration of a laminated structure in which the positive electrode, the separator, the negative electrode, and the separator are repeatedly stacked. As the lamination-type lithium secondary battery, a so-called coin-type battery, button-type battery, or paper-type (or sheet-type) battery can be exemplary examples.

For the positive electrode, the separator, the negative electrode, and the electrolytic solution constituting the lithium secondary battery, for example, the configurations, materials, and production methods described in [0113] to [0140] of WO2022/113904A1 can be used.

<all-Solid-State Lithium Secondary Battery>

Next, a positive electrode using the CAM according to one aspect of the present invention and an all-solid-state lithium secondary battery having the positive electrode will be described while describing the configuration of the all-solid-state lithium secondary battery.

FIG. 5 is a schematic view showing an example of the all-solid-state lithium secondary battery according to the present embodiment. An all-solid-state lithium secondary battery 1000 shown in FIG. 5 has a laminate 100 having a positive electrode 110, a negative electrode 120, and a solid electrolyte layer 130, and an exterior body 200 accommodating the laminate 100. In addition, the all-solid-state lithium secondary battery 1000 may have a bipolar structure in which a positive electrode active material and a negative electrode active material are disposed on both sides of a current collector. Specific examples of the bipolar structure include the structures described in JP-A-2004-95400. A material which configures each member will be described below.

The positive electrode 110 has a positive electrode active material layer 111 and a positive electrode current collector 112. The positive electrode active material layer 111 contains the above-described CAM and a solid electrolyte. In addition, the positive electrode active material layer 111 may contain a conductive material and a binder.

The negative electrode 120 has a negative electrode active material layer 121 and a negative electrode current collector 122. The negative electrode active material layer 121 contains a negative electrode active material. In addition, the negative electrode active material layer 121 may contain a solid electrolyte and a conductive material.

The laminate 100 may have an external terminal 113 which is connected to the positive electrode current collector 112 and an external terminal 123 which is connected to the negative electrode current collector 122. In addition, the all-solid-state lithium secondary battery 1000 may have a separator between the positive electrode 110 and the negative electrode 120.

The all-solid-state lithium secondary battery 1000 further has an insulator (not shown) which insulates the laminate 100 and the exterior body 200 from each other and a sealant (not shown) which seals an opening portion 200a of the exterior body 200.

As the exterior body 200, a container formed of a highly corrosion-resistant metal material such as aluminum, stainless steel or nickel-plated steel can be used. In addition, as the exterior body 200, a container obtained by processing a laminate film having at least one surface on which a corrosion resistant process has been carried out into a bag shape can also be used.

As the shape of the all-solid-state lithium secondary battery 1000, for example, shapes such as a coin-type, a button type, a paper-type (or a sheet-type), a cylindrical type, a square shape, and a laminate type (pouch type) can be exemplary examples.

As the example of the all-solid-state lithium secondary battery 1000, a form in which one laminate 100 is provided is shown in the drawing, but the present embodiment is not limited thereto. The all-solid-state lithium secondary battery 1000 may have a configuration in which the laminate 100 is used as a unit cell and a plurality of unit cells (laminates 100) is sealed inside the exterior body 200.

For the all-solid-state lithium secondary battery, for example, the configurations, materials, and production methods described in [0151] to [0181] of WO2022/113904A1 can be used.

Since the positive electrode having the above-described configuration contains the above-described CAM, it is possible to provide a lithium secondary battery having a high initial efficiency.

Furthermore, since the lithium secondary battery having the above-described configuration has the above-described positive electrode, the initial efficiency is high.

As another aspect, the present invention includes the following aspects.

[14]A method for producing a MCC powder, the method including: a step X of heating a wet cake which contains a metal composite hydroxide containing at least Ni, and moisture while flowing the wet cake in a heating device to scrape a surface of the metal composite hydroxide contained in the wet cake, in which the proportion of the moisture contained in the wet cake immediately before the step X is 5% to 21% by mass with respect to the total mass of the wet cake, and, in the step X, the proportion of the moisture contained in the wet cake immediately before the step X to the retention time of the wet cake in the heating device is 10.0% by mass/hour or less.

[15] The method for producing a MCC powder according to [14], in which the maximum retention temperature in the step X is 120° C. to 250° C.

[16] The method for producing a MCC powder according to [14] or [15], in which the retention time is 0.5 to 6 hours.

[17] The method for producing a MCC powder according to any one of [14] to [16], in which the proportion of moisture contained in the powder X immediately after the step X is 1% by mass or less with respect to the total mass of the powder X.

[18] The method for producing a MCC powder according to any one of [14] to [17], further including, before the step X: a step of neutralizing a solution containing at least a nickel salt solution under conditions of a pH of 10.5 to 11.7 and a temperature of 50° C. to 80° C.

[19] The method for producing a MCC powder according to any one of [14] to [18], further including, before the step X: a step of removing moisture from the wet cake such that a proportion of the moisture contained in the wet cake is 5% to 21% by mass with respect to the total mass of the wet cake.

[20] The method for producing a MCC powder according to any one of [14] to [19], in which the metal composite hydroxide further contains the element M.

[21]A MCC powder containing: a secondary particle which is an aggregate of a plurality of first primary particles and a plurality of second primary particles, in which the MCC powder contains at least Ni, and the A/B is 1.6 to 2.5.

[22] The MCC powder according to [21], in which the B is 0.3 to 0.8 μm.

[23] The MCC powder according to [21] or [22], in which the proportion of the moisture contained in the MCC powder is 0.01% to 0.85% by mass with respect to the total mass of the MCC powder.

[24] The MCC powder according to any one of [21] to [23], in which the D₅₀ is 7 to 18 μm.

[25] The MCC powder according to any one of [21] to [24], in which the MCC powder further contains the element M.

[26]A method for producing the CAM, including: calcining a mixture of the MCC powder according to any one of [21] to [25] and a lithium compound.

### EXAMPLES

Hereinafter, the present invention will be described in detail with examples, but the present invention is not limited to the following description.

### <Composition Analysis>

The composition analysis of the metal composite hydroxide (MCC) produced by a method described later was performed by the method of “Composition analysis of MCC” described above.

### <Average Particle Diameters of First Primary Particles and Second Primary Particles>

The average particle diameter B of the first primary particles and the average particle diameter A of the second primary particles of the MCC produced by the method described later were measured by the method of “Average particle diameters of first primary particles and second primary particles” described above.

### <Cumulative Volume Particle Size>

The average particle diameter of the secondary particles of the MCC produced by the method described later was measured by the method of “Cumulative volume particle size” described above.

### <Proportion of Moisture>

The proportion of the moisture in the wet cake and the powder (MCC) containing the metal composite hydroxide was measured by the method described in (Proportion of moisture) above.

### <Production of Positive Electrode for Lithium Secondary Battery>

A positive electrode for a lithium secondary battery was produced by the method described in “Method for producing positive electrode for lithium secondary battery” above, using CAM obtained by a production method described later.

### <Production of Lithium Secondary Battery>

A lithium secondary battery was produced by method described in “Method of producing lithium secondary battery” above, using the positive electrode for a lithium secondary battery produced by the above-described method.

### <Initial Efficiency>

For the lithium secondary battery produced by the above-described method, the initial efficiency was measured by the method described in the above-described measuring method of “Initial efficiency”.

### Example 1

After water was poured into a reaction vessel equipped with a stirrer and an overflow pipe, a sodium hydroxide aqueous solution was added thereto, and the liquid temperature was retained at 70° C.

A mixed solution was prepared by mixing a nickel sulfate aqueous solution, a cobalt sulfate aqueous solution, and an aluminum sulfate aqueous solution with a mole ratio of Ni, Co, and Al of 0.88:0.09:0.03.

Next, the mixed solution was continuously added to a reaction vessel under stirring, using an ammonium sulfate aqueous solution as a complexing agent. A sodium hydroxide aqueous solution was added dropwise thereto at appropriate times so that the pH of the mixed solution in the reaction vessel reached 11.6 (measurement temperature: 40° C.) to obtain a reaction precipitate 1.

The reaction precipitate 1 was washed with pure water to obtain a wet cake 1, and the wet cake 1 was subjected to suction filtration for dewatering such that the proportion of the moisture contained in the wet cake 1 was 19.2% by mass with respect to the total mass of the wet cake 1. The wet cake 1 was put into a rotary kiln (product name, manufactured by SHIMAKAWA SEISAKUSYO Co., Ltd.; container of a calcining furnace having a peripheral length of 1.5 m), and heated at a circumferential speed of 2 rpm, a retention time of 5 hours, and 140° C. while allowing the wet cake 1 to flow, thereby obtaining a powder 1 containing a metal composite hydroxide 1. In this case, the wall surface friction distance of the wet cake 1 in the rotary kiln was 900 m. In a case where the composition analysis of the metal composite hydroxide 1 was performed, x in Formula (A′) was 0.12, and the element M was Co and Al. In Formula (B′), y=0.12 and z=0, and the element M1 was Co and Al.

The powder containing the metal composite hydroxide 1 was heated by retaining in an atmospheric air at 650° C. for 5 hours, and cooled to room temperature to obtain a metal composite oxide powder 1.

Lithium hydroxide was weighed so that the amount (mole ratio) of Li with respect to the total amount 1 of Ni, Co, and Al contained in the metal composite oxide powder 1 reached 1.05. The metal composite oxide powder 1 and lithium hydroxide were mixed to obtain a mixture 1.

The mixture 1 was calcined at 750° C. for 5 hours in an oxygen atmosphere to obtain CAM-1.

### Example 2

After water was poured into a reaction vessel equipped with a stirrer and an overflow pipe, a sodium hydroxide aqueous solution was added thereto, and the liquid temperature was retained at 70° C.

A mixed solution was prepared by mixing a nickel sulfate aqueous solution, a manganese sulfate aqueous solution, and an aluminum sulfate aqueous solution with a mole ratio of Ni, Mn, and Al of 0.93:0.035:0.035.

Next, the mixed solution was continuously added to a reaction vessel under stirring, using an ammonium sulfate aqueous solution as a complexing agent. A sodium hydroxide aqueous solution was added dropwise thereto at appropriate times so that the pH of the mixed solution in the reaction vessel reached 11.4 (measurement temperature: 40° C.) to obtain a reaction precipitate 2.

A powder containing a metal composite hydroxide 2 was obtained by the same operation as in Example 1, except that the reaction precipitate 2 was washed with pure water to obtain a wet cake 2, and the wet cake 2 was subjected to suction filtration for dewatering such that the proportion of the moisture contained in the wet cake 2 was 18.7% by mass with respect to the total mass of the wet cake 2. In a case where the composition analysis of the metal composite hydroxide 2 was performed, x in Formula (A′) was 0.07, and the element M was Mn and Al. In Formula (B′), y=0.07 and z=0, and the element M1 was Mn and Al.

The powder containing the metal composite hydroxide 2 was heated by retaining in an atmospheric air at 650° C. for 5 hours, and cooled to room temperature to obtain a metal composite oxide powder 2.

Lithium hydroxide was weighed so that the amount (mole ratio) of Li with respect to the total amount 1 of Ni, Mn, and Al contained in the metal composite oxide powder 2 reached 1.02. The metal composite oxide powder 2 and lithium hydroxide were mixed to obtain a mixture 2.

The mixture 2 was calcined at 750° C. for 5 hours in an oxygen atmosphere to obtain CAM-2.

### Example 3

After water was poured into a reaction vessel equipped with a stirrer and an overflow pipe, a sodium hydroxide aqueous solution was added thereto, and the liquid temperature was retained at 50° C.

A mixed solution was prepared by mixing a nickel sulfate aqueous solution, a cobalt sulfate aqueous solution, and a manganese sulfate aqueous solution with a mole ratio of Ni, Co, and Mn of 0.83:0.12:0.05.

Next, the mixed solution was continuously added to a reaction vessel under stirring, using an ammonium sulfate aqueous solution as a complexing agent. A sodium hydroxide aqueous solution was added dropwise thereto at appropriate times so that the pH of the mixed solution in the reaction vessel reached 11.4 (measurement temperature: 40° C.) to obtain a reaction precipitate 3.

A powder containing a metal composite hydroxide 3 was obtained by the same operation as in Example 1, except that the reaction precipitate 3 was washed with pure water to obtain a wet cake 3, and the wet cake 3 was subjected to suction filtration for dewatering such that the proportion of the moisture contained in the wet cake 3 was 5.0% by mass with respect to the total mass of the wet cake 3. In a case where the composition analysis of the metal composite hydroxide 3 was performed, x in Formula (A′) was 0.17, and the element M was Co and Mn. In Formula (B′), y=0.17 and z=0, and the element M1 was Co and Mn.

The powder containing the metal composite hydroxide 3 was heated by retaining in an atmospheric air at 650° C. for 5 hours, and cooled to room temperature to obtain a metal composite oxide powder 3.

Lithium hydroxide was weighed so that the amount (mole ratio) of Li with respect to the total amount 1 of Ni, Co, and Mn contained in the metal composite oxide powder 3 reached 1.10. The metal composite oxide powder 3 and lithium hydroxide were mixed to obtain a mixture 3.

The mixture 3 was calcined at 650° C. for 5 hours in an oxygen atmosphere to obtain CAM-3.

### Example 4

The wet cake 2 was dewatered by suction filtration such that the proportion of the moisture contained in the wet cake 2 was 19.4% by mass with respect to the total mass of the wet cake 2. The wet cake 2 was put into a rotary kiln (product name, manufactured by SHIMAKAWA SEISAKUSYO Co., Ltd.; container of a calcining furnace having a peripheral length of 1.5 m), and heated at a circumferential speed of 2 rpm, a retention time of 2 hours, and 140° C. while allowing the wet cake 2 to flow, thereby obtaining a powder containing a metal composite hydroxide 4. In this case, the wall surface friction distance of the wet cake 2 in the rotary kiln was 360 m. In a case where the composition analysis of the metal composite hydroxide 4 was performed, x in Formula (A′) was 0.07, and the element M was Co and Al. In Formula (B′), y=0.07 and z=0, and the element M1 was Mn and Al. Subsequently, CAM-4 was obtained by performing the same operation as in Example 1 using the powder containing the metal composite hydroxide 4.

### Comparative Example 1

The wet cake 1 was put into a stationary calcining furnace (manufactured by AS ONE Corporation, FC-2000) and heated at 120° C. for 24 hours, thereby obtaining a powder containing a metal composite hydroxide C1. In a case where the composition analysis of the metal composite hydroxide C1 was performed, x in Formula (A′) was 0.12, and the element M was Co and Al. In Formula (B′), y=0.12 and z=0, and the element M1 was Co and Al. Subsequently, CAM-C1 was obtained by performing the same operation as in Example 1 using the powder containing the metal composite hydroxide C1.

### Comparative Example 2

After water was poured into a reaction vessel equipped with a stirrer and an overflow pipe, a sodium hydroxide aqueous solution was added thereto, and the liquid temperature was retained at 45° C.

A mixed solution was prepared by mixing a nickel sulfate aqueous solution, a manganese sulfate aqueous solution, and an aluminum sulfate aqueous solution with a mole ratio of Ni, Mn, and Al of 0.93:0.035:0.035.

Next, the mixed solution was continuously added to a reaction vessel under stirring, using an ammonium sulfate aqueous solution as a complexing agent. A sodium hydroxide aqueous solution was added dropwise thereto at appropriate times so that the pH of the mixed solution in the reaction vessel reached 12.5 (measurement temperature: 40° C.) to obtain a reaction precipitate 4.

A powder containing a metal composite hydroxide C2 was obtained by the same operation as in Example 1, except that the reaction precipitate 4 was washed with pure water to obtain a wet cake 4, and the wet cake 4 was subjected to suction filtration for dewatering such that the proportion of the moisture contained in the wet cake 4 was 0.75% by mass with respect to the total mass of the wet cake 4. In a case where the composition analysis of the metal composite hydroxide C2 was performed, x in Formula (A′) was 0.07, and the element M was Mn and Al. In Formula (B′), y=0.07 and z=0, and the element M1 was Mn and Al. Subsequently, CAM-C2 was obtained by performing the same operation as in Example 1 using the powder containing the metal composite hydroxide C2.

### Comparative Example 3

A powder containing a metal composite hydroxide C3 was obtained by the same operation as in Example 1, except that the wet cake 2 was subjected to suction filtration for dewatering such that the proportion of the moisture contained in the wet cake 2 was 30.4% by mass with respect to the total mass of the wet cake 2. In a case where the composition analysis of the metal composite hydroxide C3 was performed, x in Formula (A) was 0.07, and the element M was Mn and Al. In Formula (B′), y=0.07 and z=0, and the element M1 was Mn and Al. Subsequently, CAM-C3 was obtained by performing the same operation as in Example 1 using the powder containing the metal composite hydroxide C3. The A, the B, and the A/B of the powder containing the metal composite hydroxide C3, and the average particle diameter of the secondary particles were measured after the powder was put into a stationary calcining furnace (manufactured by AS ONE Corporation, FC-2000) and heated at 120° C. for 12 hours before observation with SEM, and the proportion of moisture was set to 0.56% by mass with respect to the total mass of the powder containing the metal composite hydroxide C3.

### Comparative Example 4

The wet cake 2 was dewatered by suction filtration such that the proportion of the moisture contained in the wet cake 2 was 16.5% by mass with respect to the total mass of the wet cake 2. The wet cake 2 was put into a rotary kiln (product name, manufactured by SHIMAKAWA SEISAKUSYO Co., Ltd.; container of a calcining furnace having a peripheral length of 1.5 m), and heated at a circumferential speed of 2 rpm, a retention time of 1 hour, and 140° C. while allowing the wet cake 2 to flow, thereby obtaining a powder containing a metal composite hydroxide C4. In this case, the wall surface friction distance of the wet cake 2 in the rotary kiln was 180 m. In a case where the composition analysis of the metal composite hydroxide C4 was performed, x in Formula (A′) was 0.07, and the element M was Mn and Al. In Formula (B′), y=0.07 and z=0, and the element M1 was Mn and Al. Subsequently, CAM-C4 was obtained by performing the same operation as in Example 1 using the powder containing the metal composite hydroxide C4.

In Examples 1 to 4 and Comparative Examples 1 to 4, y and z in Formula (B′), the pH in the reaction vessel (in Table 1, described as pH), the temperature in the reaction vessel, the heating method of the wet cake, the proportion of the moisture in the wet cake and in the powder (MCC) containing the metal composite hydroxide, the retention time of the wet cake in the rotary kiln or in the stationary calcining furnace (in Table 1, described as retention time), the proportion of moisture in wet cake/retention time, the A, the B, the A/B, and the D₅₀ are shown in Table 1. In addition, Table 1 shows the initial efficiency of the lithium secondary battery produced using each of MCC-1 to MCC-4, which are powders containing the metal composite hydroxides 1 to 4 of Examples 1 to 4, and MCC-C1 to MCC-C4, which are powders containing the metal composite hydroxides C1 to C4 of Comparative Examples 1 to 4.

TABLE 1

| | | | | | Proportion of moisture | | |
|---|---|---|---|---|---|---|---|
| | | | | | (% by mass) | | |
| | | | Temperature | | | MCC | |
| | y and z in | | in reaction | Heating | | (powder containing | Retention |
| | Formula | | vessel | method of | | metal composite | time |
| | (B′) | pH | (° C.) | wet cake | Wet cake | hydroxide) | (h) |
| Example 1 | 0.12, 0 | 11.6 | 70 | Flow | 19.2 | 0.72 | 5 |
| Example 2 | 0.07, 0 | 11.4 | 70 | Flow | 18.7 | 0.66 | 5 |
| Example 3 | 0.17, 0 | 11.4 | 50 | Flow | 5.0 | 0.50 | 5 |
| Example 4 | 0.07, 0 | 11.4 | 70 | Flow | 19.4 | 0.81 | 2 |
| Comparative | 0.12, 0 | 11.6 | 70 | Staying | 19.2 | 0.56 | 24 |
| Example 1 | | | | | | | |
| Comparative | 0.07, 0 | 12.5 | 45 | Flow | 0.75 | 0.52 | 5 |
| Example 2 | | | | | | | |
| Comparative | 0.07, 0 | 11.4 | 70 | Flow | 30.4 | 4.3 | 5 |
| Example 3 | | | | | | | |
| Comparative | 0.07, 0 | 11.4 | 70 | Flow | 16.5 | 7.2 | 1 |
| Example 4 | | | | | | | |

| | Proportion of | | | | | |
|---|---|---|---|---|---|---|
| | moisture in wet | primary particle | | | | |
| | cake/retention | diameter | | | | Initial |
| | time | (μm) | | | D₅₀ | efficiency |
| | (% by mass/h) | B | A | A/B | (μm) | (%) |
| Example 1 | 3.84 | 0.6 | 1.0 | 1.67 | 12.1 | 88.9 |
| Example 2 | 3.74 | 0.5 | 0.9 | 1.8 | 12.5 | 86.9 |
| Example 3 | 1.00 | 0.3 | 0.6 | 2.0 | 11.2 | 87.2 |
| Example 4 | 9.7 | 0.6 | 1.0 | 1.67 | 12.5 | 88.3 |
| Comparative | 0.80 | 0.9 | 1.0 | 1.11 | 12.1 | 82.6 |
| Example 1 | | | | | | |
| Comparative | 0.15 | 0.4 | 0.5 | 1.25 | 11.9 | 80.1 |
| Example 2 | | | | | | |
| Comparative | 6.08 | 0.8 | 0.9 | 1.13 | 12.5 | 77.8 |
| Example 3 | | | | | | |
| Comparative | 16.5 | 0.8 | 1.0 | 1.25 | 11.8 | 79.6 |
| Example 4 | | | | | | |

In MCC-1 to MCC-4 of Examples 1 to 4, the A/B was 1.5 or more. Furthermore, the initial efficiency of the lithium secondary battery using MCC-1 to MCC-4 was 83.0% or more.

On the other hand, in Comparative Example 1 in which the wet cake was heated in the stationary calcining furnace, the A/B of MCC-C1 was 1.11. In Comparative Example 2 in which the proportion of the moisture contained in the wet cake was 0.75% by mass with respect to the total mass of the wet cake, the A/B of MCC-C2 was 1.25. In addition, in Comparative Example 3 in which the proportion of the moisture contained in the wet cake was 30.4% by mass with respect to the total mass of the wet cake, the A/B of MCC-C3 was 1.13. In Comparative Example 4 in which the proportion of moisture contained in wet cake/retention time was 16.50% by mass/h, the A/B of MCC-C4 was 1.25. The initial efficiency of the lithium secondary battery using MCC-C1 to MCC-C4 was less than 83.0%.

### INDUSTRIAL APPLICABILITY

According to the present invention, it is possible to provide MCC, a method for producing MCC, and a method for producing CAM, which can obtain a lithium secondary battery having a high initial efficiency.

### REFERENCE SIGNS LIST

1: Separator; 2: Positive electrode; 2a: Positive electrode active material layer; 2b: Positive electrode current collector; 3: Negative electrode; 4: Electrode group; 5: Battery can; 6: Electrolytic solution; 7: Top insulator; 8: Sealing body; 10: Lithium secondary battery; 21: Positive electrode lead; 31: Negative electrode lead; 40: Secondary particle; 41: First primary particle; 42: Second primary particle; 100: Laminate; 110: Positive electrode; 111: Positive electrode active material layer; 112: Positive electrode current collector; 113: External terminal; 120: Negative electrode; 121: Negative electrode active material layer; 122: Negative electrode current collector; 123: External terminal; 130: Solid electrolyte layer; 200: Exterior body; 200a: Opening portion; 1000: All-solid-state lithium secondary battery

1. A method for producing a metal composite compound powder, the method comprising:
a step X of heating a wet cake which contains a metal composite hydroxide containing at least Ni, and moisture while flowing the wet cake in a heating device to scrape a surface of the metal composite hydroxide contained in the wet cake,
wherein a proportion of the moisture contained in the wet cake immediately before the step X is 5% by mass or more and 25% by mass or less with respect to a total mass of the wet cake, and
a proportion of the moisture contained in the wet cake immediately before the step X to a retention time of the wet cake in the heating device is 11% by mass/hour or less.

2. The method for producing a metal composite compound powder according to claim 1,
wherein a maximum retention temperature in the step X is 100° C. or higher and 300° C. or lower.

3. The method for producing a metal composite compound powder according to claim 1,
wherein the retention time is 0.2 to 8 hours.

4. The method for producing a metal composite compound powder according to claim 1,
wherein a proportion of moisture contained in a powder containing the metal composite hydroxide immediately after the step X is 1% by mass or less with respect to a total mass of the powder containing the metal composite hydroxide.

5. The method for producing a metal composite compound powder according to claim 1, further comprising, before the step X:
a step of neutralizing a solution containing at least a nickel salt solution under conditions of a pH of 10 or more and 13 or less and a temperature of 20° C. or higher and 80° C. or lower.

6. The method for producing a metal composite compound powder according to claim 1, further comprising, before the step X:
a step of removing moisture from the wet cake such that a proportion of the moisture contained in the wet cake is 5% by mass or more and 25% by mass or less with respect to the total mass of the wet cake.

7. The method for producing a metal composite compound powder according to claim 1,
wherein the metal composite hydroxide further contains an element M, and the element M is one or more elements selected from the group consisting of Co, Mn, Al, Fe, Cu, Ti, Mg, W, Mo, Nb, Zn, Sn, Zr, Ga, V, B, Si, S, and P.

8. A metal composite compound powder comprising:
a secondary particle which is an aggregate of a plurality of first primary particles and a plurality of second primary particles,
wherein the metal composite compound powder contains at least Ni,
when a dimension from an outermost surface of the secondary particle to a centroid in a cross section of the secondary particle is set as 100%,
the first primary particles are located in a region of less than 10% from the outermost surface of the secondary particle,
the second primary particles are located in a region of 90% or less from the centroid, and
a ratio of an average particle diameter of the second primary particles to an average particle diameter of the first primary particles is 1.5 or more.

9. The metal composite compound powder according to claim 8,
wherein the average particle diameter of the first primary particles is 0.1 μm or more and 1.0 μm or less.

10. The metal composite compound powder according to claim 8,
wherein the average particle diameter of the secondary particles is 5 μm or more and 20 μm or less.

11. The metal composite compound powder according to claim 8,
wherein a proportion of moisture contained in the metal composite compound powder is 1% by mass or less with respect to a total mass of the metal composite compound powder.

12. The metal composite compound powder according to claim 8,
wherein the metal composite compound powder further contains an element M, the element M is one or more elements selected from the group consisting of Co, Mn, Al, Fe, Cu, Ti, Mg, W, Mo, Nb, Zn, Sn, Zr, Ga, V, B, Si, S, and P.

13. A method for producing a positive electrode active material for a lithium secondary battery, the method comprising:
calcining a mixture of the metal composite compound powder according to claim 8 and a lithium compound.

14. The method for producing a metal composite compound powder according to claim 2,
wherein the retention time is 0.2 to 8 hours.

15. The method for producing a metal composite compound powder according to claim 2,
wherein a proportion of moisture contained in a powder containing the metal composite hydroxide immediately after the step X is 1% by mass or less with respect to a total mass of the powder containing the metal composite hydroxide.

16. The method for producing a metal composite compound powder according to claim 2, further comprising, before the step X:
a step of neutralizing a solution containing at least a nickel salt solution under conditions of a pH of 10 or more and 13 or less and a temperature of 20° C. or higher and 80° C. or lower.

17. The method for producing a metal composite compound powder according to claim 2, further comprising, before the step X:
a step of removing moisture from the wet cake such that a proportion of the moisture contained in the wet cake is 5% by mass or more and 25% by mass or less with respect to the total mass of the wet cake.

18. The method for producing a metal composite compound powder according to claim 2,
wherein the metal composite hydroxide further contains an element M, and the element M is one or more elements selected from the group consisting of Co, Mn, Al, Fe, Cu, Ti, Mg, W, Mo, Nb, Zn, Sn, Zr, Ga, V, B, Si, S, and P.

19. The metal composite compound powder according to claim 9,
wherein the average particle diameter of the secondary particles is 5 μm or more and 20 μm or less.

20. The metal composite compound powder according to claim 9,
wherein a proportion of moisture contained in the metal composite compound powder is 1% by mass or less with respect to a total mass of the metal composite compound powder.
